(19) United States
(12) Patent Application Publication
(10) Pub. No.: US 2018/0071696 A1
(43) Pub. Date: Mar. 15, 2018

(54) Leidenfrost Effect Based Microfluidic Mixing Device

(71) Applicant: Robert Bosch GmbH, Stuttgart (DE)

(72) Inventor: Ashwin Samarao, Sunnyvale, CA (US)

(21) Appl. No.: 15/260,370

(22) Filed: Sep. 9, 2016

(51) Int. Cl. B01F 5/00; B01L 3/00; B01F 13/00; B01F 15/02; B01F 15/06

(52) U.S. Cl. CPC B01F 5/00; B01L 3/502769; B01F 13/0064; B01F 15/0227; B01F 2005/004; B01L 2300/0867; B01L 2300/1805; B01F 2015/062; B01F 15/065

(57) ABSTRACT

A system and method for mixing fluids using a microfluidic mixing device involves heating a mixing portion of the fluid mixing channel to a Leidenfrost temperature. The Leidenfrost temperature corresponds to a Leidenfrost point of at least one of the fluids to be mixed. The fluids to be mixed are directed through the mixing portion of the fluid mixing channel after the mixing portion is heated to the Leidenfrost temperature.

### TECHNICAL FIELD

The disclosure relates generally to fluid mixing, and, in particular, to microfluidic mixing devices.

### BACKGROUND

Microfluidic mixing devices (referred to hereinafter collectively as microfluidic mixing devices) play an important role in various industries, such as the food, biological, pharmaceutical, and chemical industries. Due to the nature of microfluidic systems, fluids introduced into the mixing channel typically exhibit laminar flow characteristics. In fluid dynamics, laminar flow occurs when fluids flow in parallel layers, with little to no disruption between the layers. At low velocities, the fluid tends to flow without lateral mixing and with no cross-currents perpendicular to the direction of flow, nor eddies or swirls of fluids.

Previously known mixing devices used various passive and/or active mixing techniques to generate turbulence in mixing channels in order to speed up the mixing process. As depicted in FIG. 1, passive mixing devices typically have a serpentine or undulating geometry in order to increase the contact areas and contact times between the components being mixed. As a result, most passive mixers have complicated three dimensional geometries, occupy large areas of the microfluidic system, are difficult to fabricate, and have large associated pressure losses across the mixing element and microfluidic system. Such mixers also generally use large volumes of mixing fluids which results in considerable dead/parasitic volumes within the microfluidic system.

Active mixing devices improve mixing performance by providing forces that speed up the diffusion process between the components being mixed. Active mixing devices usually employ a mechanical transducer that agitates the fluid components to improve mixing. Some examples of transducers used in active mixers include acoustic or ultrasonic, dielectrophoretic, electrokinetic time-pulse, pressure perturbation, and magnetic transducers. In general, active mixing devices that implement such transducers can be expensive and difficult to fabricate.

### BRIEF DESCRIPTION OF THE DRAWINGS

FIG. 1 is a schematic depiction of a microfluidic mixing device according to the prior art.

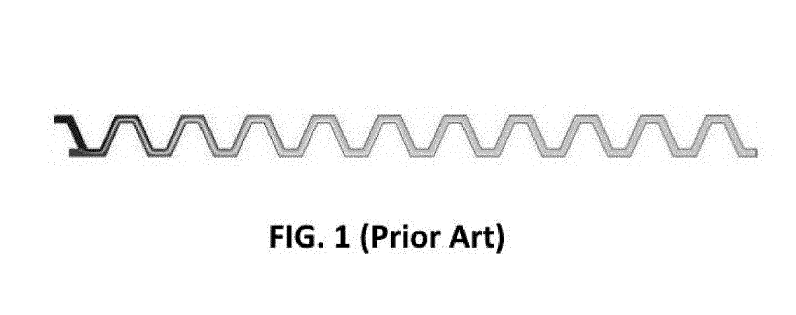

FIG. 2 is a schematic depiction of a Leidenfrost effect based microfluidic mixing device according to the disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

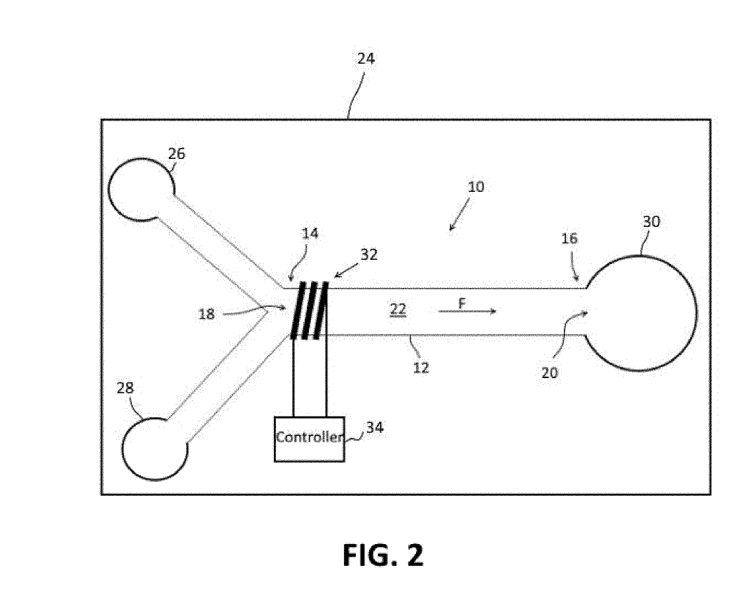

FIG. 2 depicts an embodiment of a Leidenfrost effect based microfluidic mixing device 10 according to the disclosure. The mixing device 10 includes a microfluidic mixing channel 12 in which two or more fluids are mixed as the fluids flow in the channel. The mixing channel has an inlet portion 14 and an outlet portion 16. The inlet portion 14 defines at least one inlet opening 18 into the channel via which fluids to be mixed are introduced into the channel. The outlet portion 16 defines at least one outlet opening 20 via which fluids are directed out of the mixing channel 12. Common fluids which may be mixed in the mixing channel include whole blood samples, bacterial cell suspensions, protein or antibody solutions and various buffers.

The mixing channel 12 has one or more inner walls which define a flow passage 22 within the channel 12. The flow passage 22 may have any suitable closed cross-sectional shape, such as elliptical and polygonal shapes, and may define any suitable path between the inlet portion and outlet portion of the channel. As part of a microfluidic device, the flow passage 22 has at least one dimension perpendicular to the direction of flow F within the channel that is less than 1 mm and in various embodiments may be in the micrometer and nanometer range. As depicted in FIG. 2, the mixing channel 12 defines a generally straight path between the inlet portion 14 and the outlet portion 16. In alternative embodiments, other suitable shapes for the channel may be used including serpentine, undulating, curves, sharp corners and combinations thereof.

The mixing channel 12 may be formed of any suitable material(s), such as polymer, glass, silicon, and the like. The material used for the mixing channel must be capable of withstanding temperatures at or above the Leidenfrost points of the fluids to be mixed in the channel (explained in more detail below). The same material may be used to form the entire passage. In alternative embodiments, different portions of the channel may be formed of different materials.

In one embodiment, the mixing channel 12 is formed in a substrate or semiconductor chip 24 for integration into a miniaturized device, such as a lab-on-a-chip system. The mixing channel 12 may be formed on or in the substrate or semiconductor chip 24 in any suitable manner including molding, patterning, and other microfabrication techniques. The structures and components of the chip-based microfluidic mixing device 10 may be fabricated using a number of integrated circuit microfabrication techniques such as electroforming, laser ablation, anisotropic etching, sputtering, dry and wet etching, photolithography, casting, molding, stamping, machining, spin coating, laminating, among others, and combinations thereof.

The mixing device 10 may include one or more fluid inlet reservoirs 26, 28 which are in fluid communication with the fluid inlet opening(s) 18 of the mixing channel 12. The fluid inlet reservoirs 26, 28 are configured retain fluids (not shown) which are to be introduced into the channel. The mixing device 10 may also include one or more fluid outlet reservoirs 30 which are in fluid communication with the outlet opening(s) 20 of the mixing channel 12. The fluid outlet reservoir 30 is configured to receive the mixed fluids from the mixing channel 12. The size of the fluid reservoirs may be any suitable size depending on the type of fluids and application of the device. In chip-based microfluidic mixing devices, the fluid reservoirs may be integrated into the device along with the fluid mixing channel. The mixing device is configured to utilize a fluid actuation device (not shown) for driving the flow of fluid through the mixing channel. The fluid actuation device may comprise a pumping device, such as a syringe pump, an electrostatic fluid actuator, or the like.

As an alternative to passive and active mixing elements and techniques used in the prior art, the mixing device 10 of the disclosure includes a heater structure 32 which is configured to generate turbulence in the mixing channel based on the Leidenfrost effect. The Leidenfrost effect occurs when a liquid comes into contact with a solid that is at a Leidenfrost temperature for the liquid. The Leidenfrost temperature is a temperature that is well above the liquid's boiling point. When a liquid contacts a solid that is at the Leidenfrost temperature of the liquid, the part of the liquid droplet contacting the solid vaporizes immediately. The resulting vapor layer is interposed between the liquid droplet and the solid and prevents any further direct contact between the droplet and the heated solid. Because vapor has much poorer thermal conductivity than liquid, further heat transfer between the solid and the liquid droplet is slowed down dramatically. The vapor layer therefore acts as an insulator which slows down the evaporation of the droplet. The Leidenfrost effect also causes the droplet to move chaotically around on the solid. The chaotic movement of Leidenfrost droplets can be used to generate turbulence in a fluid flow. Such turbulence can significantly increase the speed and efficiency of the mixing process.

The heater structure 32 is positioned in thermal contact with at least a portion of the mixing channel 12. The region of the mixing channel 12 where the heater structure 32 is positioned is referred to herein as the mixing region. Any suitable type of heating system or methodology may be implemented by the heater structure 32. The heater structure 32 is configured to heat the mixing region of the mixing channel 12 to the Leidenfrost temperature of at least one fluid that is introduced into the mixing channel. For example, the Leidenfrost temperature of water-based fluids is approximately 193° C. The Leidenfrost temperature for a fluid may be temperature range within which the fluid exhibits the Leidenfrost effect. The Leidenfrost temperature or temperature range of a fluid may determined in any suitable manner, including empirical methods, modeling methods and estimating methods.

In one embodiment, the heater structure 32 comprises a Joule heater. The Joule heater is formed of any suitable material that is capable of generating and releasing heat when an electric current is passed through the material, such as metals, oxides, nitrides, and the like. The material used to form the heater structure as well as the physical characteristics of the heater structure, such as size, shape, thermal conductivity, and the like, depend at least in part on the temperature levels to be generated by the heater structure.

In one embodiment, the Joule heater 32 comprises a strip of resistance heating material that is wrapped around the mixing region of the channel 12. Alternatively, the Joule heater may comprise a planar resistance material layer that is positioned in thermal contact with one side of the mixing channel. The resistance material may be deposited onto the mixing region of the channel in any suitable manner including atomic layer deposition (ALD), plasma-enhanced chemical vapor deposition (PECVD), low-pressure chemical vapor deposition (LPCVD) and the like.

The mixing device includes a heater controller 34 which is configured to supply an electric current of an appropriate magnitude to the heater 32 to cause the heater to generate the Leidenfrost temperature. In one embodiment, the electric current for the heater structure is supplied by a controller 34. Controller 34 may comprise a processor (not shown), such as a central processing unit (CPU), an application specific integrated circuit (ASIC), a field programmable gate array (FPGA) device, or a micro-controller, that is configured to execute programmed instructions that are stored in a memory (not shown). Any suitable type of memory may be used. The controller 34 includes appropriate hardware for generating the current for the heater structure. In alternative embodiments, the heater structure may be supplied an electric current in response to actuation of a control element (not shown) such as a switch, pushbutton or the like. Alternatively,

The turbulence generated by the heater structure 32 due to the Leidenfrost effect enables mixing to occur much faster than previously known passive mixing schemes. This enables a significant reduction in the length and complexity of the mixing channel. For example, mixing channel can comprise a straight channel having a length less than 1 cm, and in particular, less than 1 mm. In some embodiments, the mixing channel may have a length that is in the range from tens to hundreds of micrometers.

According to one specific example, the resistance material comprises platinum having a thickness of 5 nm and a thermal conductivity of 1×10⁻⁵ W/K and a resistance of 3000 hms. Applying a voltage of 3 V across the heater structure can drive a current of 1 mA through the heater. The power (P) utilized by the heater in this instance is given by the formula: P=I²*R where I is the current through the heater (1 mA) and R is the resistance of the heater (3000 ohms). The power (P) in this case is therefore equal to 3 mW. Since the thermal conductivity is 1×10⁻⁵ W/K, the heater will generate a temperature of 300° C. with a power consumption of only 3 mW. A temperature of 300° C. is within the Leidenfrost temperature range of water-based liquids. Consequently, the heater structure can momentarily drive the fluids in the mixing channel into a turbulent mass facilitating instant and complete mixing of the fluids in the mixing channel thereby obviating the need for long, undulating mixing channels and at a power consumption of only 3 mW.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A microfluidic mixing device comprising:
a fluid mixing channel having a fluid inlet portion, a fluid outlet portion and a mixing portion extending between the fluid inlet portion and the fluid outlet portion;
a first and a second fluid inlet in fluid communication with the fluid inlet portion of the channel, each of the first and the second fluid inlets being configured to introduce a fluid into the fluid mixing channel;
a heater structure in thermal contact with the mixing portion of the fluid mixing channel, the heater structure being configured to heat the mixing portion of the fluid mixing channel to a Leidenfrost temperature,
wherein the Leidenfrost temperature corresponds to a Leidenfrost point of at least one fluid introduced into the fluid mixing channel.

2. The microfluidic mixing device of claim 1, wherein the mixing portion of the fluid mixing channel is straight.

3. The microfluidic mixing device of claim 2, wherein the heater structure comprises a Joule heater.

4. The microfluidic mixing device of claim 3, wherein the Joule heater is formed of platinum.

5. The microfluidic mixing device of claim 4, wherein the platinum is 5 nm thick.

6. The microfluidic mixing device of claim 3, wherein the Joule heater is wrapped around the mixing channel.

7. The microfluidic mixing device of claim 3, further comprising:
a heater controller configured to supply an electric current to the Joule heater.

8. The microfluidic mixing device of claim 1, further comprising:
at least one pump configured to pump fluids through the fluid mixing channel.

9. The microfluidic mixing device of claim 1, wherein the fluid mixing channel, the first and the second fluid inlets and the heater structure are integrated onto a single microchip.

10. The microfluidic mixing device of claim 1, wherein the at least two fluids inlets are configured to introduce fluids into the fluid mixing channel with a laminar flow.

11. A method of mixing at least two fluids in a microfluidic mixing device; the method comprising:
heating a mixing portion of the fluid mixing channel to a Leidenfrost temperature, the Leidenfrost temperature corresponding to a Leidenfrost point of at least one of the at least two fluids;
directing the at least two fluids through the mixing portion of the fluid mixing channel after the mixing portion is heated to the Leidenfrost temperature.

12. The method of claim 11, wherein the mixing portion of the fluid mixing channel is straight.

13. The method of claim 12, wherein the mixing portion of the fluid mixing channel is heated using a Joule heater.

14. The method of claim 13, wherein the Joule heater is formed of platinum.

15. The method of claim 14, wherein the platinum is 5 nm thick.

16. The method of claim 13, wherein the Joule heater is wrapped around mixing portion of the fluid mixing channel.
